(19) United States
(12) Patent Application Publication
(10) Pub. No.: US 2020/0143458 A1
(43) Pub. Date: May 7, 2020

(54) VEHICLE MANAGEMENT DEVICE, CAR SHARING SYSTEM, AND VEHICLE MANAGEMENT METHOD

(71) Applicant: TOYOTA JIDOSHA KABUSHIKI KAISHA, Toyota-shi (JP)

(72) Inventors: Michio IKEDA, Nagoya-shi (JP); Kohei UEZATO, Nissin-shi (JP); Yoshihiro OHE, Nissin-shi (JP); Masashi YAMADA, Aisai-shi (JP); Kenichi KOMURO, Nagoya-shi (JP); Toshiaki NIWA, Okazaki-shi (JP)

(73) Assignee: TOYOTA JIDOSHA KABUSHIKI KAISHA, Toyota-shi (JP)

(21) Appl. No.: 16/666,521

(22) Filed: Oct. 29, 2019

(30) Foreign Application Priority Data
Nov. 5, 2018 (JP) 2018-208140

(51) Int. Cl. G06Q 30/06

(52) U.S. Cl. CPC G06Q 30/0645

(57) ABSTRACT

A receiving section configured to receive a usage application message containing use start time of a vehicle intended for car sharing and a rent-out place of the vehicle, an identification section configured to, based on a current position of a transporter vehicle that is able to transport the vehicle, identify the transporter vehicle that reaches the rent-out place by the use start time, a first sending section configured to send a move instruction message to the transporter vehicle identified by the identification section to instruct the transporter vehicle to move to the rent-out place, and a second sending section configured to send information on the vehicle that is being transported by the transporter vehicle identified by the identification section to a source from which the usage application message is sent, are provided.

### INCORPORATION BY REFERENCE

The disclosure of Japanese Patent Application No. 2018-208140 filed on Nov. 5, 2018 including the specification, drawings and abstract is incorporated herein by reference in its entirety.

### BACKGROUND

### 1. Technical Field

The disclosure relates to a vehicle management device, a car sharing system, and a vehicle management method.

### 2. Description of Related Art

Japanese Unexamined Patent Application Publication No. 2012-215921 (JP 2012-215921 A) describes a system that distributes usage loads on car stations where vehicles for car sharing are parked.

### SUMMARY

In JP 2012-215921 A, when car sharing is implemented in the center of a city, places where a parking lot is provided are limited. Therefore, there is often no parking lot near user's base or user's circulation, which causes a decrease in user convenience.

The disclosure provides a vehicle management device, car sharing system, and vehicle management method that improve user convenience.

A vehicle management device according to an aspect of the disclosure includes a receiving section configured to receive a usage application message containing use start time of a vehicle intended for car sharing and a rent-out place of the vehicle, an identification section configured to, based on a current position of a transporter vehicle that is able to transport the vehicle, identify the transporter vehicle that reaches the rent-out place by the use start time, a first sending section configured to send a move instruction message to the transporter vehicle identified by the identification section to instruct the transporter vehicle to move to the rent-out place, and a second sending section configured to send information on the vehicle that is being transported by the transporter vehicle identified by the identification section to a source from which the usage application message is sent.

In the above aspect, the identification section may be configured to, when there is no transporter vehicle that reaches the rent-out place by the use start time, identify the transporter vehicle that reaches the rent-out place earliest.

In the above aspect, the identification section may be configured to, when there is no transporter vehicle that reaches the rent-out place by the use start time, identify the vehicle located closest to the rent-out place at the use start time, and the second sending section may be configured to send information on the vehicle identified by the identification section and located closest to the rent-out place to a source from which the usage application message is sent.

In the above aspect, the receiving section may be configured to further receive a drop-off application message containing a drop-off place where the vehicle is dropped off, and the first sending section may be configured to send drop-off information containing information on the vehicle to be dropped off and the drop-off place to the transporter vehicle.

In the above aspect, the identification section may be configured to further identify the transporter vehicle that reaches the drop-off place earliest, and the first sending section may be configured to send the drop-off information to the transporter vehicle identified by the identification section as the transporter vehicle that reaches the drop-off place earliest.

A car sharing system according to another aspect of the disclosure includes an information terminal carried by a user who uses a car sharing service, a communication device mounted on a transporter vehicle that is able to transport a vehicle intended for car sharing, and a vehicle management device configured to manage the user, the vehicle, and the transporter vehicle. The information terminal includes a sending section configured to send a usage application message containing use start time of the vehicle and a rent-out place of the vehicle, and a receiving section configured to receive information on the vehicle associated with the usage application message. The vehicle management device includes a receiving section configured to receive the usage application message, an identification section configured to, based on a current position of the transporter vehicle, identify the transporter vehicle that reaches the rent-out place by the use start time, a first sending section configured to send a move instruction message to the communication device associated with the transporter vehicle identified by the identification section to instruct the transporter vehicle to move to the rent-out place, and a second sending section configured to send information on the vehicle that is being transported by the transporter vehicle identified by the identification section to the information terminal that is a source from which the usage application message is sent. The communication device includes a receiving section configured to receive the move instruction message.

A vehicle management method according to another aspect of the disclosure is a vehicle management method that is executed by a processor, and includes a receiving step of receiving a usage application message containing use start time of a vehicle intended for car sharing and a rent-out place of the vehicle, an identifying step of, based on a current position of a transporter vehicle that is able to transport the vehicle, identifying the transporter vehicle that reaches the rent-out place by the use start time, a first sending step of sending a move instruction message to the transporter vehicle identified in the identifying step to instruct the transporter vehicle to move to the rent-out place, and a second sending step of sending information on the vehicle that is being transported by the transporter vehicle identified in the identifying step to a source from which the usage application message is sent.

According to the disclosure, a vehicle management device, a car sharing system, and a vehicle management method that improve user convenience are provided.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram that illustrates the configuration of a car sharing system according to an embodiment;

FIG. 2 is a sequence chart for illustrating an example of the operation of the car sharing system according to the embodiment;

FIG. 3 is a sequence chart for illustrating an example of the operation of the car sharing system according to the embodiment; and

FIG. 4 is a sequence chart for illustrating an example of the operation of a car sharing system according to a modification.

### DETAILED DESCRIPTION OF EMBODIMENTS

An exemplary embodiment of the disclosure will be described with reference to the accompanying drawings. In the drawings, like reference numerals denote the same or similar components.

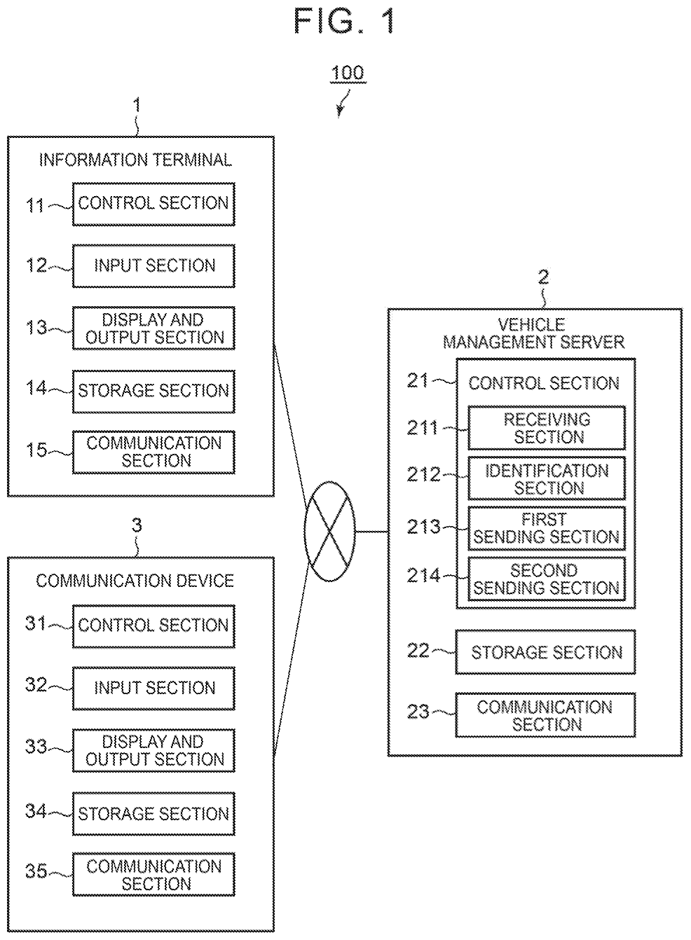

The configuration of a car sharing system according to the embodiment will be described with reference to FIG. 1. The car sharing system 100 includes, for example, an information terminal 1, a communication device 3, and a vehicle management server (vehicle management device) 2. The information terminal 1 is a terminal that is carried by each user who uses a car sharing service. The communication device 3 is mounted on each transporter vehicle that is able to transport a vehicle for car sharing (hereinafter, also referred to as sharing car). The vehicle management server 2 is used to manage the user(s), the vehicle(s), and the transporter vehicle(s). The information terminal 1, the vehicle management server 2, and the communication device 3 are configured to be able to communicate with one another via a network including, for example, a wireless network.

In the present embodiment, an ultra-small mobility including an electromotive vehicle to ride in a standing position or in a sitting position for one or two persons is used as the sharing car. The transporter vehicle may be any vehicle that is able to transport an ultra-small mobility. An existing vehicle, such as a truck, a bus, a taxi, and an ordinary vehicle, may be used as the transporter vehicle. For example, an ultra-small mobility may be transported while being loaded on the roof of a taxi, ordinary vehicle, or the like.

The information terminal 1 shown in FIG. 1 is, for example, a terminal device, such as a smartphone. The information terminal 1 includes, for example, a control section (a sending section and a receiving section) 11, an input section 12, a display and output section 13, a storage section 14, and a communication section 15, as functional components. The information terminal 1 includes, for example, a control unit including a central processing unit (CPU) and a memory, an operating unit, a display, a speaker, a storage unit, a communication unit, and the like, as physical components. When the CPU runs a predetermined program stored in the memory, the functions of the control section 11, input section 12, display and output section 13, storage section 14, and communication section 15 are implemented.

The communication device 3 includes, for example, a control section (receiving section) 31, an input section 32, a display and output section 33, a storage section 34, and a communication section 35, as functional components. The communication device 3 includes, for example, a control unit including a CPU and a memory, an operating unit, a display, a speaker, a storage unit, a communication unit, and the like, as physical components. When the CPU runs a predetermined program stored in the memory, the functions of the control section 31, input section 32, display and output section 33, storage section 34, and communication section 35 are implemented.

The vehicle management server 2 includes, for example, a control section 21, a storage section 22, and a communication section 23, as functional components. The vehicle management server 2 includes, for example, a control unit including a CPU and a memory, a storage unit, a communication unit, and the like, as physical components. When the CPU runs a predetermined program stored in the memory, the functions of the control section 21, storage section 22, and communication section 23 are implemented.

The vehicle management server 2, for example, stores user information on each user who uses the car sharing service, vehicle information on each sharing cars, and transporter vehicle information on each transporter vehicle, respectively in databases, or the like, and manages these pieces of information.

The user information contains, for example, a user ID that identifies each user, the name of the user, the contact information of the user, the vehicle ID of the sharing car that the user is using, and the like.

The vehicle information contains, for example, a vehicle ID that identifies each sharing car, the model of the sharing car, the current position of the sharing car, the use status information of the sharing car, and the like. The use status information of a sharing car contains, for example, information that indicates whether the sharing car is being used by a user, the user ID of the user who uses the sharing car, use start time, a use start place, scheduled return time, a scheduled return place, and the like.

The transporter vehicle information contains, for example, a transporter vehicle ID that identifies each transporter vehicle, the model of the transporter vehicle, the current position of the transporter vehicle, the vehicle ID of a sharing car that the transporter vehicle is transporting, and the like.

The vehicle management server 2 where necessary collects traffic information including traffic congestion information from, for example, a traffic information center, or the like, stores the traffic information in a database, or the like, and manages the traffic information.

The function of the control section 21 of the vehicle management server 2 will be described in detail below. The control section 21 includes, for example, a receiving section 211, an identification section 212, a first sending section 213, and a second sending section 214.

The receiving section 211, for example, receives various messages, including a usage application message and a drop-off application message, from the information terminal 1.

A usage application message is a message that is sent from the information terminal 1 when a user applies for the use of a sharing car. A usage application message contains, for example, information that is required to apply for use, such as the use start time of a sharing car and the rent-out place of a sharing car.

A drop-off application message is a message that is sent from the information terminal 1 when a user drops off a sharing car. A drop-off application message contains, for example, information that is required to apply for drop-off, such as a drop-off place where a sharing car is dropped off.

When a usage application message has been received, the identification section 212 identifies a transporter vehicle that reaches a rent-out place by use start time based on the current position of each transporter vehicle. The current position of each transporter vehicle is acquired by consulting the transporter vehicle information that is managed in the database. The use start time and the rent-out place are acquired from the received usage application message.

The identification section 212 specifically identifies a transporter vehicle as follows.

(1) The identification section 212 searches for a route from the current position of each transporter vehicle to a rent-out place.
(2) The identification section 212 calculates predicted arrival time by adding a time required for the found route to current time.
(3) The identification section 212 identifies a transporter vehicle whose calculated predicted arrival time is before use start time.

When a plurality of transporter vehicles has been identified, a transporter vehicle that reaches a rent-out place earliest may be selected or a user may be allowed to select any one of the identified transporter vehicles.

When the identification section 212 calculates predicted arrival time in the above (2), the identification section 212 may consult traffic congestion information that is managed in the database and may add an estimated passage time of a traffic congestion section that is present between the current position of a transporter vehicle and a rent-out place to the predicted arrival time.

When there is no transporter vehicle that reaches a rent-out place by use start time, the identification section 212 identifies a transporter vehicle that reaches the rent-out place earliest after the use start time.

When a drop-off application message has been received, the identification section 212 identifies a transporter vehicle that reaches a drop-off place earliest based on the current position of each transporter vehicle. The drop-off place is acquired from the received drop-off application message. Predicted arrival time at the drop-off place can be calculated similarly to the above-described predicted arrival time at the rent-out place.

The first sending section 213 sends a move instruction message and drop-off information to the communication device 3 mounted on the transporter vehicle identified by the identification section 212.

A move instruction message is a message to instruct the transporter vehicle to move to the rent-out place based on the received usage application message. A move instruction message contains, for example, a rent-out place, use start time, information on a user who uses a sharing car, and the like.

Drop-off information is information for causing a transporter vehicle to head for a drop-off place based on a received drop-off application message. Drop-off information contains, for example, the vehicle ID of a sharing car to be dropped off, the model of the sharing car, a drop-off place, drop-off time, and the like.

The second sending section 214 sends rent-out vehicle information on the sharing car that is being transported by the transporter vehicle identified by the identification section 212 to the information terminal 1 that is a source of the usage application message. Rent-out vehicle information is information for providing the details of a rent-out vehicle to a user who has applied for the use of a sharing car. Rent-out vehicle information contains, for example, the vehicle ID of a sharing car, a rent-out place, use start time, information on a transporter vehicle that is transporting the sharing car, and the like.

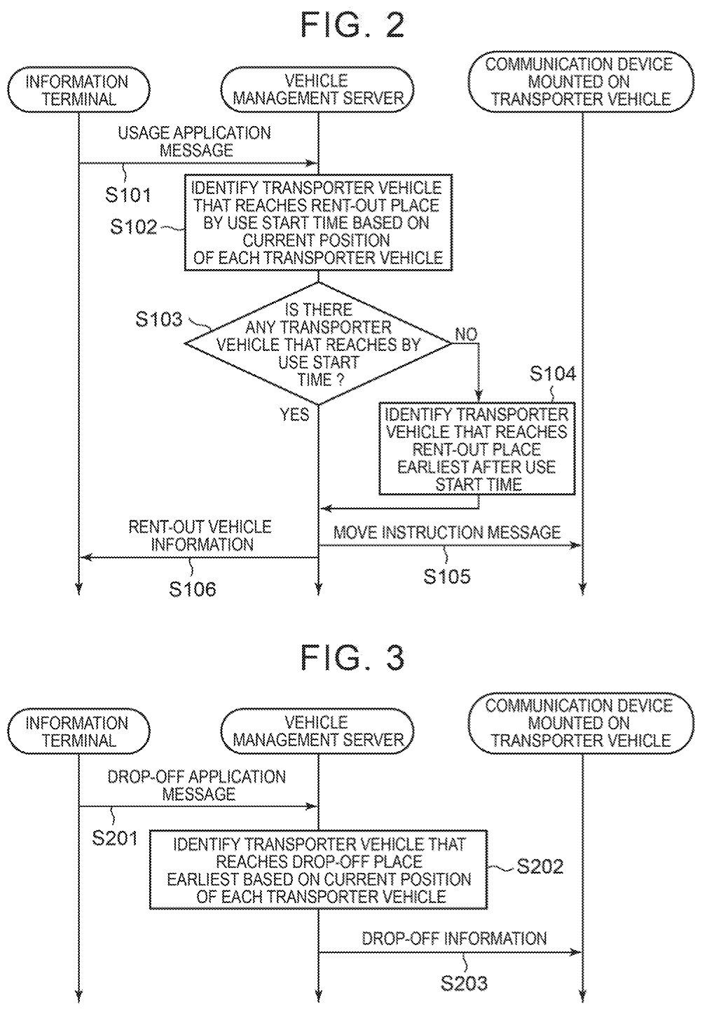

An example of the operation of the car sharing system 100 in the embodiment will be described with reference to FIG. 2 and FIG. 3. FIG. 2 is a sequence chart that shows an example of the operation to apply for the use of a sharing car.

First, the information terminal 1 sends a usage application message in accordance with a user's operation instruction (step S101). A user's operation instruction contains, for example, an operation to input information that is required to apply for the use of a sharing car, such as use start time and a rent-out place, an operation to send input information, and the like. As for a rent-out place, for example, the current position of the information terminal 1 may be set in a rent-out place setting field by default, and the user may be allowed to change the rent-out place optionally.

Subsequently, the identification section 212 of the vehicle management server 2 identifies a transporter vehicle that reaches the rent-out place by the use start time based on the usage application message received by the receiving section 211, and the current position of each transporter vehicle (step S102).

Subsequently, the identification section 212 of the vehicle management server 2 determines whether there is any transporter vehicle that reaches the rent-out place by the use start time (step S103). When the determination is affirmative (YES in step S103), the process proceeds to step S105 (described later).

On the other hand, when the identification section 212 of the vehicle management server 2 determines in step S103 that there is no transporter vehicle that reaches the rent-out place by the use start time (NO in step S103), the identification section 212 of the vehicle management server 2 identifies a transporter vehicle that reaches the rent-out place earliest after the use start time (step S104).

Subsequently, the first sending section 213 of the vehicle management server 2 sends the move instruction message to the communication device 3 mounted on the transporter vehicle identified in step S102 or step S104 (step S105). A transporter vehicle associated with the communication device 3 that has received the move instruction message starts moving to the rent-out place contained in the move instruction message.

Subsequently, the second sending section 214 of the vehicle management server 2 sends the rent-out vehicle information of a sharing car that is being transported by the transporter vehicle identified in step S102 or step S104 to the information terminal 1 that has sent the usage application message in step S101 (step S106). The user of the information terminal 1 that has received the rent-out vehicle information can check the transporter vehicle heading for the rent-out place or information on the sharing car. Then, the operation ends.

FIG. 3 is a sequence chart that shows an example of the operation to drop off a sharing car.

First, the information terminal 1 sends a drop-off application message in accordance with a user's operation instruction (step S201). A user's operation instruction contains, for example, an operation to input information that is required to apply for the drop-off of a sharing car, such as a drop-off place, an operation to send input information, and the like. As for a drop-off place, for example, the current position of the information terminal 1 may be set in a drop-off place setting field by default, and the user may be allowed to change the drop-off place optionally.

Subsequently, the identification section 212 of the vehicle management server 2 identifies a transporter vehicle that reaches the drop-off place earliest based on the drop-off application message received by the receiving section 211 and the current position of each transporter vehicle (step S202).

Subsequently, the first sending section 213 of the vehicle management server 2 sends the drop-off information to the communication device 3 mounted on the transporter vehicle identified in step S202 (step S203). A transporter vehicle associated with the communication device 3 that has received the drop-off information starts moving to the drop-off place contained in the drop-off information. Then, the operation ends.

As described above, with the car sharing system 100 in the embodiment, when the vehicle management server 2 receives a usage application message containing the use start time and rent-out place of a sharing car from the information terminal 1, the vehicle management server 2 is able to identify a transporter vehicle that reaches the rent-out place by the use start time based on the current position of each transporter vehicle that transports a sharing car, send a move instruction message to the identified transporter vehicle to instruct the identified transporter vehicle to move to the rent-out place, and send information on the sharing car that is being transported by the transporter vehicle to the information terminal 1 that has sent the usage application message.

With this configuration, even when there is no parking lot near user's base or user's circulation, the user can get on a sharing car in a selected rent-out place designated by the user. Therefore, with the car sharing system 100 in the embodiment, user convenience is improved.

With the car sharing system 100 in the embodiment, when there is no transporter vehicle that reaches a rent-out place by use start time, the vehicle management server 2 is able to identify a transporter vehicle that reaches the rent-out place earliest. With this configuration, although a certain amount of standby time takes from use start time, a user can get on a sharing car in any rent-out place designated by the user.

Furthermore, with the car sharing system 100 in the embodiment, when the vehicle management server 2 receives a drop-off application message containing a drop-off place of a sharing car from the information terminal 1, the vehicle management server 2 is able to identify a transporter vehicle that reaches the drop-off place earliest and send drop-off information containing information on a sharing car to be dropped off and the drop-off place to the identified transporter vehicle. With this configuration, a sharing car to be dropped off can be quickly collected, so a user is allowed to drop off a sharing car in any place.

Modification

The disclosure is not limited to the above-described embodiment, and may be implemented in other various forms without departing from the purport of the disclosure. Therefore, the above-described embodiment is only illustrative in all respects and should not be interpreted restrictively. For example, the order of the above-described processing steps may be changed optionally or may be executed in parallel without any contradiction in processing details.

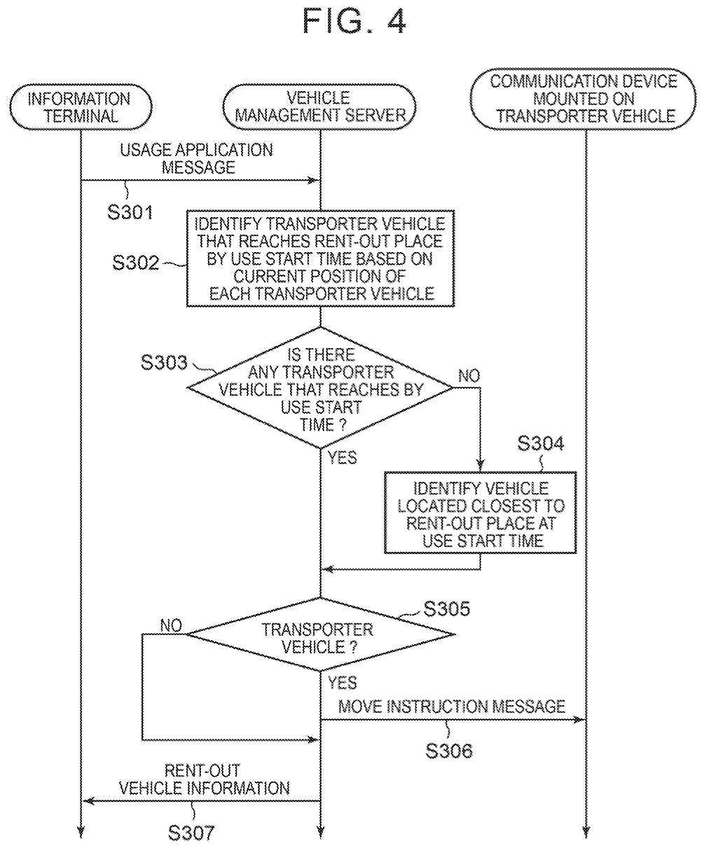

In the above-described embodiment, when there is no transporter vehicle that reaches a rent-out place by use start time, the identification section 212 identifies a transporter vehicle that reaches the rent-out place earliest; however, a target to be identified is not limited to a transporter vehicle. For example, a sharing car may be identified. In this case, in addition to a sharing car that is being transported by a transporter vehicle, a sharing car that is parked in a fixed parking lot may be included in a target to be identified. In this modification, an example of the operation to apply for the use of a sharing car will be described with reference to FIG. 4.

The processes of step S301 to step S303 shown in FIG. 4 are similar to the above-described processes of step S101 to step S103 shown in FIG. 2. Therefore, the description thereof is omitted.

In step S303 of FIG. 4, when it is determined that there is a transporter vehicle that reaches a rent-out place by use start time (YES in step S303), the process proceeds to step S305 (described later).

On the other hand, in step S303, when it is determined that there is no transporter vehicle that reaches the rent-out place by the use start time (NO in step S303), the identification section 212 of the vehicle management server 2 identifies a vehicle located closest to the rent-out place at the use start time (step S304).

Subsequently, the first sending section 213 of the vehicle management server 2 determines whether the vehicle identified in step S302 or step S304 is a transporter vehicle (step S305). When the determination is negative (NO in step S305), the process proceeds to step S307 (described later).

In step S305, when it is determined that the identified vehicle is a transporter vehicle (YES in step S305), the second sending section 214 of the vehicle management server 2 sends a move instruction message to the communication device 3 mounted on the transporter vehicle identified in step S302 or step S304 (step S306). A transporter vehicle associated with the communication device 3 that has received the move instruction message starts moving to the rent-out place contained in the move instruction message.

Subsequently, the second sending section 214 of the vehicle management server 2 sends the rent-out vehicle information of the sharing car that is being transported by the transporter vehicle identified in step S302 or step S304 or the rent-out vehicle information of the sharing car identified in step S304 to the information terminal 1 that has sent the usage application message in step S301 (step S307). The user of the information terminal 1 that has received the rent-out vehicle information can check information on a transporter vehicle or sharing car heading for the rent-out place or information on a sharing car parked closest to the rent-out place. Then, the operation ends.

With the car sharing system 100 in this modification, when there is no transporter vehicle that reaches a rent-out place by use start time, the vehicle management server 2 is able to identify a vehicle located closest to the rent-out place at the use start time and send information on the identified vehicle to the information terminal 1 that has sent a usage application message. With this configuration, although a user is required to slightly move from a rent-out place designated by the user, the user can get on a sharing car near any rent-out place designated by the user.

In the above-described embodiment, the first sending section 213 sends drop-off information to the communication device 3 mounted on a transporter vehicle identified by the identification section 212; however, a destination to which drop-off information is sent is not limited thereto. For example, drop-off information may be sent to the communication devices 3 of all the transporter vehicles or may be sent to the communication devices 3 of all the transporter vehicles present within a predetermined range from a drop-off place.

The components of the information terminal 1, vehicle management server 2, and communication device 3 are not limited to the components in the above-described embodiment. Any component may be added as needed.

What is claimed is:

1. A vehicle management device comprising:
a receiving section configured to receive a usage application message containing use start time of a vehicle intended for car sharing and a rent-out place of the vehicle;
an identification section configured to, based on a current position of a transporter vehicle that is able to transport the vehicle, identify the transporter vehicle that reaches the rent-out place by the use start time;
a first sending section configured to send a move instruction message to the transporter vehicle identified by the identification section to instruct the transporter vehicle to move to the rent-out place; and
a second sending section configured to send information on the vehicle that is being transported by the transporter vehicle identified by the identification section to a source from which the usage application message is sent.

2. The vehicle management device according to claim 1, wherein the identification section is configured to, when there is no transporter vehicle that reaches the rent-out place by the use start time, identify the transporter vehicle that reaches the rent-out place earliest.

3. The vehicle management device according to claim 1, wherein:
the identification section is configured to, when there is no transporter vehicle that reaches the rent-out place by the use start time, identify the vehicle located closest to the rent-out place at the use start time; and
the second sending section is configured to send information on the vehicle identified by the identification section and located closest to the rent-out place to a source from which the usage application message is sent.

4. The vehicle management device according to claim 1, wherein:
the receiving section is configured to further receive a drop-off application message containing a drop-off place where the vehicle is dropped off; and
the first sending section is configured to send drop-off information containing information on the vehicle to be dropped off and the drop-off place to the transporter vehicle.

5. The vehicle management device according to claim 4, wherein:
the identification section is configured to further identify the transporter vehicle that reaches the drop-off place earliest; and
the first sending section is configured to send the drop-off information to the transporter vehicle identified by the identification section as the transporter vehicle that reaches the drop-off place earliest.

6. A car sharing system comprising:
an information terminal carried by a user who uses a car sharing service;
a communication device mounted on a transporter vehicle that is able to transport a vehicle intended for car sharing; and
a vehicle management device configured to manage the user, the vehicle, and the transporter vehicle, wherein:
the information terminal includes
a sending section configured to send a usage application message containing use start time of the vehicle and a rent-out place of the vehicle, and
a receiving section configured to receive information on the vehicle associated with the usage application message,
the vehicle management device includes
a receiving section configured to receive the usage application message,
an identification section configured to, based on a current position of the transporter vehicle, identify the transporter vehicle that reaches the rent-out place by the use start time,
a first sending section configured to send a move instruction message to the communication device associated with the transporter vehicle identified by the identification section to instruct the transporter vehicle to move to the rent-out place, and
a second sending section configured to send information on the vehicle that is being transported by the transporter vehicle identified by the identification section to the information terminal that is a source from which the usage application message is sent, and
the communication device includes a receiving section configured to receive the move instruction message.

7. A vehicle management method that is executed by a processor, the vehicle management method comprising:
a receiving step of receiving a usage application message containing use start time of a vehicle intended for car sharing and a rent-out place of the vehicle;
an identifying step of, based on a current position of a transporter vehicle that is able to transport the vehicle, identifying the transporter vehicle that reaches the rent-out place by the use start time;
a first sending step of sending a move instruction message to the transporter vehicle identified in the identifying step to instruct the transporter vehicle to move to the rent-out place; and
a second sending step of sending information on the vehicle that is being transported by the transporter vehicle identified in the identifying step to a source from which the usage application message is sent.
